(19) United States
(12) Patent Application Publication
(10) Pub. No.: US 2025/0229700 A1
(43) Pub. Date: Jul. 17, 2025

(54) METHOD FOR OPERATING A HEADLIGHT DEVICE FOR A VEHICLE, AND MOTOR VEHICLE HAVING A HEADLIGHT DEVICE

(71) Applicant: CARIAD SE, Wolfsburg (DE)

(72) Inventor: Karsten BERGER, Wolfsburg (DE)

(21) Appl. No.: 18/703,273

(22) PCT Filed: Oct. 19, 2022
(86) PCT No.: PCT/EP2022/079082

§ 371 Date: Apr. 19, 2024

(30) Foreign Application Priority Data
Oct. 20, 2021 (DE) 10 2021 127 180.0

(51) Int. Cl. B60Q 1/14; B60Q 1/20; B60Q 1/24

(52) U.S. Cl. CPC B60Q 1/143; B60Q 1/249; B60Q 1/20; B60Q 2300/112; B60Q 2300/312

(57) ABSTRACT

A method for operating a headlight device for a vehicle is provided and may include emitting monochromatic light of multiple predetermined different wavelengths from a light source, determining a respectively backscattered amount of light and/or luminance with reference to the respectively emitted wavelength, identifying wavelengths of light which fall below a predetermined level of backscattered light, and operating the headlight device with monochromatic light having the identified wavelengths.

### BACKGROUND

### Technical Field

The disclosure relates to a method for operating a headlight device for a vehicle, a computer program product for this method, and a motor vehicle with a headlight device.

### Description of the Related Art

In motor vehicles, bulbs are used for fog headlights, which emit a wide spectrum of light. Although this light spectrum is multicolored, it appears to the human eye as white light due to the superimposition of the colors. Other bulbs for fog headlights have an unchanging monochromatic light. In fog or heavy rain, the light can be scattered by the water droplets, which means that a large proportion of the light can be reflected back diffusely. Therefore, in many cases, a driver can be affected by glare caused by their own fog headlights. In case of heavy fog, glare can occur also when using high beam. This problem is currently being addressed by adjusting the light intensity and/or geometry of the fog headlight based on an intensity of light reflected back. In this case, the respective light source is automatically switched off if it causes glare for the driver. A further approach includes the adjustment of the intensity as a function of the amount of light reflected back.

In this context, the published patent application DE 102011077282A1 describes a spectral control for lamps. It describes a lighting system for a motor vehicle, which has a lighting means or device and a control means or device associated therewith.

Using a position detection means or device, a position of the motor vehicle can be detected and information about a prevailing color range in the surroundings of the detected position can be read out via an onboard memory. The control means or device is configured to control the color spectrum of the emitted light as a function of the prevailing color spectrum of the surroundings.

A possible reduction in the illuminance or luminance of the fog headlights or even turning them off can reduce the amount of light reflected back and thus protect the driver from unnecessary glare, but this light can then be missing from the illumination of the surroundings. In this case, the driver's view would still be considerably restricted by adverse weather conditions such as fog or heavy rain. The same may apply to sensor technology of autonomous driving functions. For example, a front camera of the motor vehicle no longer can record useable pictures or videos in such a situation. In this case, the driver is usually forced to adapt his/her driving style accordingly. Typically, in this case, the speed of the motor vehicle is reduced.

One object can be seen in being able to operate a headlight device even in unfavorable weather conditions, thereby reducing causing glare for a driver and/or sensors.

### BRIEF SUMMARY

A first aspect the disclosure therefore provides a method for operating a headlight device for a vehicle. In a first Step a, multiple light sources are provided, each individual light source of these multiple light sources being configured to emit monochromatic light of a predetermined wavelength, the wavelengths being different. This means that the multiple light sources can generate different light in the form of different wavelengths, but at the same time, at an emission event, can generate and/or emit light of a predetermined wavelength, that is to say monochromatic light. For example, up to 100 different wavelengths can be provided for the respective monochromatic light. Starting from 300 nm, different light could be emitted in steps of 10 nm by the light sources. This happens preferably step by step, i.e., successively. For this purpose, the light sources may comprise one or more LEDs. Here, each individual LED or light source can emit monochromatic light with one or more predetermined wavelengths. Light can be described by way of photons, which exhibit one respective frequency. On the other hand, light can also be an electromagnetic wave. In the context of the wave-particle dualism known from quantum physics light can be a particle and/or a wave. The light or rays of light can exhibit properties of a particle and/or properties of an electromagnetic wave.

In monochromatic light, the associated photons have the same frequency. Monochromatic light can be referred to as light of a single color. Monochromatic light may be an electromagnetic radiation or wave with a precisely defined frequency or a fixed vacuum wavelength. Typically, it is difficult to provide perfectly monochromatic light, but it is sufficient if the monochromatic light fluctuates only slightly around a given frequency or wavelength. Here, a tolerance range of 1, 2, 3, 4, 5, 6, 7, 8, 9 or 10 nanometers around the defined wavelength may still be considered monochromatic light. It is possible for light to be regarded as monochromatic light, when it fluctuates by up to 10 percent around the predetermined wavelength. The tolerance range can be up to 10 percent around the predetermined wavelength. The monochromatic light can be characterized either by its wavelength or by its frequency. The term “light” can mean the same as “light rays.” Using the relationship f=c/λ a frequency of monochromatic light can be converted to the wavelength, and vice versa. F represents the frequency, c represents the speed of light in vacuum, and λ represents the wavelength.

In a further Step b of the method, monochromatic light or monochromatic light rays is/are emitted at a plurality of the multiple predetermined wavelengths. In particular, multiple test rays of different colors can be emitted. The different light rays may be emitted by the light sources one after the other in time. A light spectrum from monochromatic light, that is to say light with predetermined wavelengths can be emitted one after the other, i.e., successively, with only light of the predetermined wavelength being able to be emitted at a specific time. For example, the light source can, at first, emit light having only a first wavelength and, at a later second time, emit light having only a second wavelength. Each different color may be represented by corresponding monochromatic light rays. A predetermined light spectrum can be emitted successively. For example, monochromatic light can be emitted starting from 300 nanometers, and, thereafter, monochromatic light with a wavelength of 350, 400, . . . 1,200 nanometers can be emitted. The wavelength of monochromatic light can be up to 2 millimeters. Thus, a given set of monochromatic light rays can be emitted gradually.

In a further Step c, an amount of backscattered light and/or backscattered luminance can be determined with respect to the wavelength emitted in each case. For this purpose, for example, the amount of light reflected back can be measured using a light sensor. The amount of light can be measured using a light sensor or a spectral sensor. An active pixel sensor can be utilized as a light sensor, for example. An active pixel sensor may be a semiconductor detector for measuring light. The active pixel sensor is often called a CMOS sensor. An intensity of backscattered light and/or a backscattered luminance can be measured using the light sensor and/or the CMOS sensor.

In a further Step d, those wavelengths of the monochromatic light of the multiple different wavelengths may be identified which fall below a predetermined amount of backscattered light. In this step, it can be identified which wavelength and/or frequency of the associated monochromatic light causes a minimum of backscatter. Thus, the frequency can be identified at which the intensity of backscattered light or luminance is minimal. Typically, however, it is sufficient if the backscattering falls below the predetermined level. The luminance of a surface may determine how bright the surface is perceived. The unit of the luminance is candela per square meter (cd/m²). The luminance is defined in particular as quotient of the luminous intensity and the luminous surface. On the other hand, the light intensity is a basic quantity of the international unit system, and its unit is candela (cd). One candela is preferably defined using a radiation source. One candela is the light intensity of a radiation source which emits monochromatic light of frequency 540 Terahertz with a ray intensity of 1/683 Watt/sr (sr=steradian) in one specific direction. Depending on the context, the amount of backscattered light can relate to the light intensity or the luminance. The light intensity therefore provides specifically information as to how much light is emitted in one particular direction, while the luminance normalizes the light intensity to a given area.

On the other hand, the term illuminance refers to the luminous flux, which is normalized with respect to a given area. The luminous flux is represented by multiplying luminous intensity and a solid angle irradiated. The unit of luminous flux is preferably lumen, the unit of illuminance is preferably lux (lumens per square meter). The amount of backscattered light can be stated or measured based on the light intensity, the luminance, the luminous flux and/or the illuminance. Depending on the headlight device, a quantity or unit may be used depending on the ease in measuring such a quantity or unit. The term amount of light can mean luminous intensity, luminance, illuminance and/or luminous flux mean. The luminance can be measured and used for the purpose of the method.

In a further Step e, the headlight device may be operated exclusively with such a monochromatic light, which has the wavelengths identified. Therefore, the headlight device may only emit monochromatic light which exhibits low backscattering, i.e., monochromatic light which falls below the predetermined level in the amount of backscattered light. Thus, a part of the light spectrum may not be emitted by the headlight device. The headlight device can then be set so that only the monochromatic light with exactly this particularly low-scattering light color is emitted. This allows, for example, a fog light or a high beam to be operated despite unfavorable weather conditions, without causing glare of the driver or of the vehicle sensor. This allows visibility for the driver or the vehicle sensor to be maintained or increased. This enables achievement of a significant increase in traffic safety.

Visibility or view typically refers to a maximum horizontal distance that just allows a dark object near the ground to be seen against a light background. Visibility can be estimated visually or measured instrumentally. For example, visibility sensors can measure light scattered by particles in an atmosphere and determine visibility therefrom. For example, a forward scattering method can be used to measure visibility. Visibility sensors are known and are used regularly in the area of traffic engineering and/or weather technology. In this respect the person skilled in the art knows appropriate visibility sensors, for example, from weather technology.

In some embodiments, Steps b, c and/or d are executed repeatedly at predetermined time intervals. Such embodiments may be executed by a moving vehicle. Such embodiments enable the headlight device to optimally re-adjust to changing environmental conditions. For example, the weather conditions around the vehicle may change, resulting in a corresponding change in the amount of backscattered light for corresponding monochromatic wavelengths. In such embodiments, it may be necessary to use another monochromatic light ray to operate the headlight device. Re-executing the above method steps enables flexible reactions to new environmental conditions around the vehicle.

Additionally or alternatively, executing Steps b, c and/or d can be re-executed as a function of an environmental parameter. The environmental parameter can be a fog density, an ambient atmosphere of the headlight device and/or a visibility range in the area of the headlight device, for example. The ambient atmosphere of the headlight device can comprise, for example, a brightness, a temperature and/or a humidity of the surroundings of the vehicle. The fog density can be described as being based on an impaired view of an observer looking towards the azimuth. Thus, instead of the fog density, a derived quantity of the visibility can be used for fog density. The environmental parameter can be chosen so that changing weather conditions are quickly recognized. In this way, the light frequency or light wavelength for operating the headlight device can be determined, which exhibits the least scattering or at least does not exceed a predetermined level of backscattering. As a result, an area around the vehicle or the headlight device can be better illuminated and the driving functions or an autonomous driving function can be operated more effectively based on a higher visibility range. This can result in a better contrast and surrounding objects around the headlight device can be detected earlier, which benefits traffic safety. Under certain circumstances, it may be possible to drive at a higher speed without having to accept a reduction in driving safety.

The selected or identified light frequency or wavelength for the monochromatic light can be adjusted dynamically or at high frequency. For example, if the weather conditions change abruptly, for example in the form of a reduced visibility range or if heavy rain suddenly begins, the monochromatic light can be adjusted quickly by appropriately adjusting the monochromatic light rays in the form of a changed light frequency. In some embodiments, executing Steps b, c and/or d may be a function of a rate of change or a gradient concerning the environmental parameter. The rate of change or the gradient can impact repetition frequency.

In some embodiments, the headlight device is operated with a first wavelength of monochromatic light in a range visible to a person, and with a second wavelength of monochromatic light in a range not visible for a person. The first wavelength may be a value from the range 380 nm to 800 nm. The assumption is made that the person can see light in the range 380 nm to 800 nm. The range 380 nm to 800 nm can be considered a visible range. The second wavelength may be defined between 900 nm and 2 millimeters. The person can be considered a standard person or an average person with average vision. In the case of ametropia, the assumption is made that the person is wearing visual aids such as glasses or contact lenses. The assumption is made that the person cannot see light of the second wavelength. Wavelengths of the second wavelength can therefore be assigned to a non-visible range. It is possible to operate the headlight device in particular only using light of these two wavelengths. The headlight device can only emit light of the first and/or second wavelength(s). The second wavelength may be used for operating a vehicle sensor. Switching between these two wavelengths may be carried out dynamically at a frequency of at least 60 Hertz.

The visible range can be in a wavelength range from 380 to 780 nanometers. The second wavelength can be in a wavelength range from 850 nanometers to 1 millimeter. The visible range may correspond to a frequency from 380 to 700 THz. The second wavelength may to a frequency range between 300 gigahertz and 375 THz. The visible range may correspond to light that can be noticed by the human eye, while the second wavelength may be found in the range of thermal radiation or infrared radiation. In some embodiments, light of the first wavelength may be used to illuminate surroundings of the vehicle for a human driver, while the second wavelength can be designed for a camera, such as an infrared camera. Thus, the first wavelength may represent the light frequency most suitable for the human eye, while the second wavelength may represent the best light frequency for an imaging sensor system such as the camera, for example.

The camera may be a vehicle sensor. This can be a particular advantage, because, for example, in the near infrared range particularly little light is reflected by water. From the technical perspective in terms of reflection, the second wavelength is satisfactory for an infrared camera. However, the second wavelength in the infrared range is not suitable to illuminate the surroundings of the vehicle for a driver. As a result, the surroundings of the headlight device or of the vehicle can be illuminated optimally for both the human eye and the vehicle sensor, especially the camera. If switching between these two wavelengths or frequencies is done sufficiently quickly, i.e., switching back and forth, the headlight device appears optimally as a homogeneous light source. Good illumination of the surroundings of the vehicle can thus be achieved both for the driver and the vehicle sensor. At one sufficiently high switching frequency of 60 Hertz or more, ideally a human driver, the person, will not notice this switching.

In some embodiments, the vehicle sensor may be a camera and a picture or a video sequence with multiple pictures may be produced exactly when the second wavelength is emitted or reflected. The video sequence can be viewed as sequence of multiple pictures taken at different times. The camera can be an infrared camera. The vehicle sensor or the camera may be activated exactly when the non-visible light, i.e., the second wavelength of light, is emitted. Alternatively, the camera can be activated exactly when the non-visible light is backscattered. Identifying the ideal monochromatic light rays can also be utilized taking into account other materials such as, for example, dust or sand. The headlight device can thus be operated flexibly and optimally under different environmental scenarios. Accordingly, it is possible to adapt the headlight device to new situations.

In some embodiments, light with exactly the first wavelength and light with exactly the second wavelength may be identified. The light can be emitted in the form of light rays with the first and/or the second wavelength. The light with the first and second wavelengths has the lowest amount of backscattered light and/or luminance in their respective ranges. When the headlight device is operated, dynamic switching occurs between these two wavelengths. In some embodiments, a frequency of at least 60 Hertz is used to alternate between these two wavelengths. A frequency of 80, 90, 100 or 1,000 Hertz can be used for switching. Such a frequency ensures the best possible illumination of the surroundings for both the driver and an autonomous driving function, i.e., for the vehicle sensor. Dynamic switching between these two wavelengths is particularly advantageous, because both the vehicle sensor and the driver can benefit from good illumination. Due to the switching, the vehicle sensor can still operate optimally in the range of the second wavelength because of the optimal illumination.

In some embodiments, light with wavelengths that, during backscattering, exceed a predetermined limit value concerning the backscattered amount of light and/or backscattered luminance may be excluded when operating the headlight device while emitting the respective monochromatic light rays at the plurality of the predetermined different wavelengths (Step b) for a given time interval. At the step of identifying the wavelengths, which fall below a given level of backscattered light (Step d), it can also be determined which wavelengths cause a high level of backscattered light. This means that a resonance effect during backscattering can be detected for certain wavelengths. In order to reliably exclude strong glare effects in continued operation of the headlight device, such embodiments provide that these wavelengths, which generate a high level of backscatter, will not be used when operating the headlight device, that is to say they will be excluded. This exclusion can relate to a given time interval. In some embodiments, exclusion may refer to emitting monochromatic light, which may precede determining the amount of backscattered light. This can prevent the occurrence of short-term glare effects when the monochromatic light rays are emitted to identify the amount of backscattered light. If, for example, in a very foggy environment it is known that a certain wavelength leads to a high level of glare, then exactly this wavelength can be excluded when identifying the amount of backscattered light, since in this case it is already known that glare would be caused. Additionally, as a result, unwanted glare can be reliably avoided during the step of identifying those wavelengths (Step d).

In some embodiments, during operation of the headlight device of the vehicle, a visibility range may be identified and a speed of the motor vehicle may be set as a function of the visibility range. Such embodiments can be utilized in autonomous vehicles or semi-autonomous vehicles. In some embodiments, the speed of vehicle will be reduced at a lower visibility range accordingly. The term visibility range can refer to the first wavelength or the second wavelength. Thus, the visibility range can mean a visibility range of the human eye as well as a visibility range of the vehicle sensor. If, for example, the visibility range for the human driver is not reduced, however, it is reduced for the vehicle sensor, the speed of the vehicle can still be reduced. This allows autonomous driving functions to automatically adapt to a reduced visibility range. Alternatively or additionally, it is possible that in case of a reduced visibility range in the visible range, that is to say in the range of the first wavelength, a provision may be made to reduce the speed of the vehicle. In such embodiments, a control unit of the motor vehicle can generate a corresponding control signal for the motor vehicle. In some embodiments, the method for operating the headlight device can reduce or avoid a reduction of the visibility range. This can reduce the need to reduce the speed of the vehicle or, in the best case, eliminate it.

A second aspect of this disclosure relates to a headlight device for a vehicle. The headlight device may have one light source or multiple light sources. The light source may be configured to emit monochromatic light of multiple predetermined different wavelengths. Each individual light source of the multiple light sources can emit monochromatic light to the predetermined different light sources. The light source can be a light strip, multiple LED elements, a halogen lamp and/or a gas discharge lamp. The light source can also be implemented in the form of a pixel light headlight. All of these light sources are designed in particular to emit predetermined monochromatic light wavelengths. The headlight device further has a light sensor for measuring an amount of backscattered light and/or luminance. The headlight device can have a control unit. The control unit may configured to emit monochromatic light rays to a plurality of the multiple predetermined wavelengths by way of the light source. The control unit can, in connection with the light sensor, determine an amount of backscattered light and/or luminance with respect to the respective emitted wavelength of the monochromatic light. The control unit can further identify every wavelength of the monochromatic light that falls below a predetermined level of the amount of backscattered light. The predetermined level can be 1, 2, 3, 4 or 5 percent of the emitted luminous intensity or luminous flux, or a measured backscattered luminance can be converted into the quantities luminous flux or luminous intensity to identify the predetermined level. In addition, the control unit can control the headlight device in such a way that the headlight device is operated exclusively with the monochromatic light that has the identified wavelengths.

A third aspect of the disclosure relates to a computer program product. The computer program product comprises commands configured to cause the control unit of the headlight device to execute at least one of the described embodiments. Thus, the control unit may comprise commands that can implement each of the described embodiments.

A fourth aspect of the disclosure relates to a vehicle having a headlight device and/or with a computer program product. The computer program product can be integrated in the control unit.

The features presented in connection with the method according to the first aspect of the disclosure and their advantages apply accordingly to the headlight device according to the second aspect of the disclosure, the computer program product according to the third aspect of the disclosure, and the vehicle according to the fourth aspect of the disclosure, and vice versa. This means that device features can be interpreted as method features, and vice versa.

The vehicle can comprise a computer program which includes commands configured to cause any embodiment(s) of the method to be executed. The computer program product may be stored on a computer-readable medium.

The disclosure also includes the control unit for the vehicle. The control unit can have a data processing device or a processor device that is configured to execute at least one embodiment of the method according to the disclosure. For this purpose, the processor device can have at least one microprocessor and/or at least one microcontroller and/or at least one FPGA (Field Programmable Gate Array) and/or at least one DSP (Digital Signal Processor). Furthermore, the processor device can have program code that is configured, when executed by the processor device, to execute at least one embodiment of the method according to the disclosure. The program code can be stored in a data storage unit of the processor device.

The disclosure also includes refinements of the method according to the disclosure, which have features such as those already described in connection with refinements of the vehicle according to the disclosure. For this reason, the corresponding refinements of the method according to the disclosure are not described again here.

The vehicle may be configured as a motor vehicle, car, such as a passenger car or truck, or as a passenger bus or motorcycle. The vehicle can be an aircraft or plane.

The disclosure also comprises the combinations of the features of the described embodiments. The disclosure therefore also comprises implementations that each exhibit a combination of the features of multiple of the described embodiments, provided the embodiments have not been described as being mutually exclusive.

### BRIEF DESCRIPTION OF THE SEVERAL VIEWS OF THE DRAWINGS

The disclosure will now be explained in more detail with reference to the accompanying drawings. It should be noted that the drawings only show exemplary options as to how the disclosure may be implemented. Under no circumstances the drawings should be viewed as limiting or even exclusive options.

FIG. 1 shows a schematic side view of a vehicle with a headlight device.

FIG. 2 shows a schematic outline of the headlight device.

### DETAILED DESCRIPTION

The exemplary embodiments explained below are preferred embodiments of the disclosure. In the exemplary embodiments, the described components of the embodiments each represent individual features of the disclosure that are to be viewed independently of one another, which refine the disclosure also independently from one another. Therefore, the disclosure also comprises combinations of the features of the embodiments other than those depicted. Furthermore, the described embodiments can also be supplemented by further features of the disclosure that have already been described. In the figures the same reference numerals describe functionally identical elements.

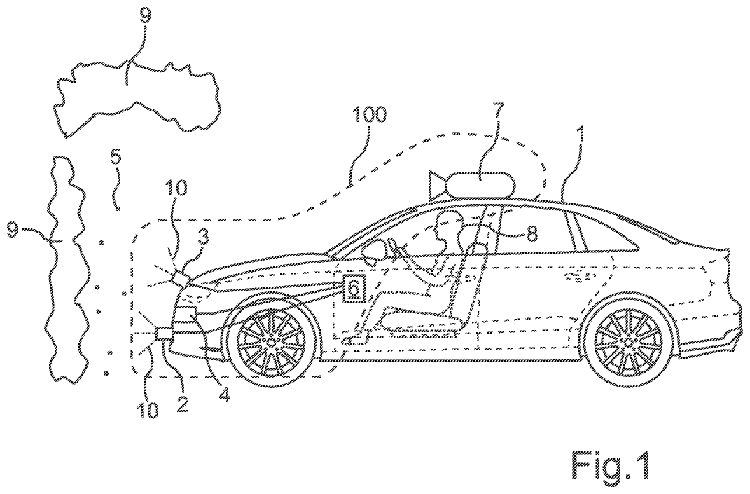

FIG. 1 shows for example a vehicle 1 with a headlight device 100. Headlight device 100 may include a left headlight 2, a right headlight 3, an image sensor 4 a control unit 6, and a vehicle sensor 7. Headlights 2, 3 can each have one or more light sources or may be designed as pixel light headlights. Headlight device can be part of vehicle 1. Vehicle sensor 7 may be configured as a camera. Vehicle sensor 7 can also be an ultrasonic sensor, radar sensor and/or lidar sensor. A person 8 can be seen in vehicle 1. The left headlight 2 and the right headlight 3 emit light 10. In the example of FIG. 1, the respective light wavelengths or frequencies of light 10 will not yet be addressed. Light 10 is often white light which exhibits a plurality of different wavelengths in typical headlights. A cloud 9 is indicated in front of vehicle 1. Cloud 9 can, for example, represent fog, heavy rain, dust and/or sand.

In cloud 9 and/or in the surroundings of vehicle 1, scattering material may be present. Scattering material 5 can be in the form of water droplets, dust and/or sand. Scattering material 5 can be regarded as scattering particles 5. Any material which can backscatter emitted light 10 can be considered as scattering material 5. Headlights 2, 3 or headlight device 100 may be configured to enable an optimal illumination and a high visibility range for driver 8 or vehicle sensor 7.

However, scattering particles 5 can result in unpleasant backscatter, which can affect or even impede driver 8 or vehicle sensor 7. The level of backscattering, i.e., the amount of backscattered light, can be a function of the frequency of the emitted light or the wavelength of the emitted light 10.

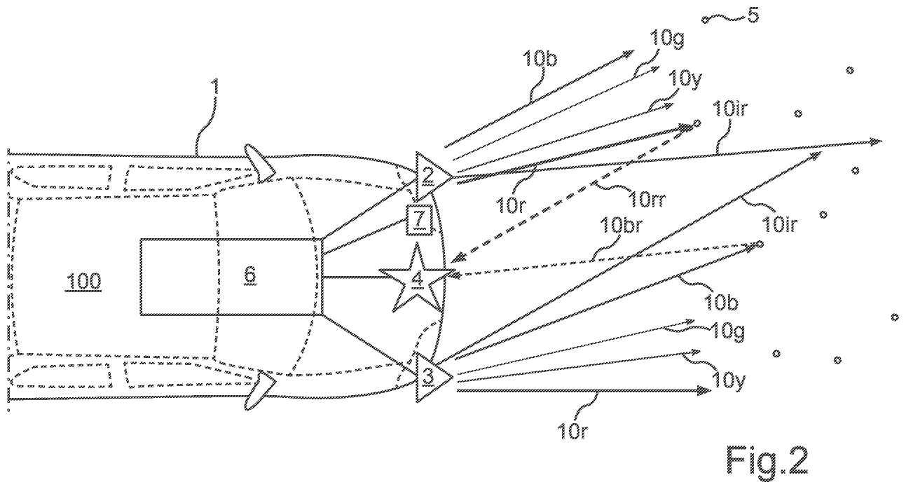

FIG. 2 shows headlight device 100 with headlights 2, 3 and vehicle sensor 7 and image sensor 4, and control unit 6. Image sensor 4 can be configured as a light sensor, CMOS sensor, and/or active pixel sensor. Control unit 6 can include a computer program product or can be implemented as part of a computer program product. Each of headlights 2, 3 may have at least one light source. This light source can produce and emit different monochromatic light wavelengths. In FIG. 2, on the right, different light rays 10b to 10y are indicated. 10b represents blue, 10g green, 10r red, 10y yellow light. 10ir represents infrared light which is not visible to humans. These different light rays 10b to 10y represent photons of different frequencies. Different light rays are often classified based on their color and not based of their wavelength or frequency. Each color represents an associated frequency or wavelength of the associated light ray 10b to 10y.

Certain light rays are shown as dashed lines, with the reflected light ray 10br, 10rr pointing back to headlight device 100. These light rays can be scattered back by scattering particles 5. In the case of FIG. 2, this concerns light rays 10rr and 10br. This means that red light rays 10r and blue light rays 10b can be scattered back by scattering particles 5.

When identifying those monochromatic light rays which lead to a minimum and/or maximum of the amount of backscattered light, control unit 6 can, based on a predetermined sequence, emit a predetermined spectrum of light rays of different wavelengths. Using light sensor 4, it can be determined at the same time which wavelength leads to a corresponding amount of backscattering of light. The amount of light can be determined by measuring the luminous intensity, luminance, luminous flux and/or illuminance. This means that an associated backscattering can be determined for each wavelength. In the example of FIG. 2, red and blue light rays 10b, 10r result in an increased light backscattering (reflected light rays 10br, 10rr). On the other hand, yellow light rays 10y and green light rays 10g show no backscatter in the example of FIG. 2. Additionally, FIG. 2 shows infrared light rays 10ir. Infrared light rays 10ir exhibit, for example, a wavelength of more than 1,000 nanometers. Infrared rays 10ir are not visible for a human eye. However, infrared rays 10ir may be optimal for vehicle sensor 7.

Based on the detected backscattering, control unit 6 can use image sensor 4 to analyze or to determine which light rays or which associated wavelength result(s) in minimal backscattering or to identify which wavelengths do not exceed a predetermined level of backscattering. The optimal frequency or optimal wavelength can be in the non-visible spectrum. In the case of FIG. 2, these would be light rays of infrared range 10ir. Even if infrared rays 10ir exhibit the least backscatter, infrared rays 10ir are not suitable for the driver 8 to illuminate the surroundings of the vehicle 1.

Therefore, control unit 6 identifies one more wavelength or frequency for the light, that is in the visible range, that is to say in the wavelength range between 380 and 780 nanometers, which also does not exceed the predetermined level of backscatter. The predetermined level of backscatter can be less than 10 percent of the emitted luminous intensity or luminous flux, such as less than 5 percent, preferably less than 2 percent. Below, it is assumed that the green light rays 10g have the lowest backscattering in the visible range to provide an illustrative example. In this case, the control unit can switch back and forth between green light rays 10g and infrared rays 10ir.

Control unit 6 can ensure that there is a change between these two light rays 10g and 10ir in the visible and non-visible spectrum. For this purpose, control unit 6 can control headlights 2, 3 accordingly. Vehicle sensor 7 may be always triggered when the non-visible light, i.e., infrared rays 10ir, is/are emitted. Vehicle sensor 7 can be a front camera, which is only sensitive in the infrared range. This enables the surroundings of the infrared camera as a vehicle sensor 7 to be optimally illuminated. The dynamic switching between the visible light (green light rays 10g) and the non-visible light (infrared rays 10ir) enables optimal ambient illumination for both driver 8 and vehicle sensor 7. This means a visibility range can be increased for both driver 8 and vehicle sensor 7, such as, for example for the infrared camera.

Headlight device 100 can be utilized not only in a foggy environment or in heavy rain. Headlight device 100 can also develop its advantages in an environment with dust or sand. In such embodiments, control unit 6 can identify the corresponding wavelengths at which light 10 is reflected at scattering particles 5. Accordingly, as described above, those light rays can be determined that do not exceed the predetermined level of backscatter, and left headlight 2 and right headlight 3 can accordingly be operated with that monochromatic light, which has a low backscattering of light. This means that optimal illumination both for the driver and the vehicle sensor 7 can always be achieved, even in changing environmental conditions, which benefits traffic safety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a headlight device for a vehicle, the method comprising:
emitting monochromatic light from each light source of a plurality of light sources, each light source of the plurality of light sources being configured to emit monochromatic light of a predetermined wavelength, each predetermined wavelength of each of the plurality of light sources being different from each other, the monochromatic light being emitted at a plurality of the plurality of predetermined wavelengths,
determining a backscattered amount of light and/or luminance with respect to each respective emitted wavelength,
identifying wavelengths of monochromatic light of the plurality of predetermined wavelengths which fall below a predetermined level of backscattered amount of light and/or luminance, and
operating the headlight device exclusively with that monochromatic light which has the identified wavelengths.

2. The method according to claim 1, wherein the determining, identifying, and operating steps are repeatedly executed at predetermined time intervals and/or as a function of an environmental parameter.

3. The method according to claim 1, wherein the headlight device is operated with monochromatic light having a first wavelength in a range between 380 nm and 800 nm and with a second wavelength in a range between 900 nm and two millimeters, wherein the second wavelength is used for operating a vehicle sensor, and wherein the monochromatic light is dynamically switched between the first and second wavelengths.

4. The method according to claim 3, wherein the vehicle sensor is a camera, and the method further comprises producing a picture or a video sequence with multiple pictures when the second wavelength is emitted or backscattered.

5. The method according to claim 3, wherein the first wavelength and the second wavelength are identified as wavelengths having the smallest amount of backscattered light and/or luminance in the respective ranges, and, when operating the headlight device, the monochromatic light dynamically switches between these first and second wavelengths.

6. The method according to claim 2, wherein wavelengths of light are excluded for a predetermined time interval for each emission step when operating the headlight device, the excluded wavelengths of light being those in which the backscatter amount of light and/or luminance exceeds a predetermined limit value.

7. The method according to claim 1, wherein, during operation of the headlight device of the vehicle, visibility is identified, and a speed of the vehicle is set as a function of the visibility.

8. A headlight device for a vehicle, comprising:
a plurality of light sources, each light source of the plurality of light sources configured to emit monochromatic light at a predetermined wavelength, each predetermined wavelength of each of the plurality of light sources being different from each other,
a light sensor configured to measure a backscattered amount of light and/or luminance,
a control unit configured:
to emit monochromatic light at a plurality of the plurality of predetermined wavelengths by way of the light sources,
to determine a backscattered amount of light and/or luminance with respect to each respective emitted wavelength by way of the light sensor
to identify wavelengths of the monochromatic light of the plurality of predetermined wavelengths which fall below a predetermined level of backscattered amount of light and/or luminance, and
to operate the headlight device exclusively with that monochromatic light having the identified wavelengths.

9. A vehicle with a headlight device according to claim 8.

10. The method according to claim 2, wherein the environmental parameter is a fog density, an ambient atmosphere of the headlight device, and/or a visibility in an environment of the headlight device.

11. The method according to claim 3, wherein the monochromatic light is dynamically switched between the first and second wavelengths at a frequency of at least 60 Hz.

12. The method according to claim 4, wherein the vehicle sensor is an infrared camera.
